(19) United States
(12) Patent Application Publication
(10) Pub. No.: US 2006/0024415 A1
(43) Pub. Date: Feb. 2, 2006

(54) Method for prevention of temperature overshoot in a cooking appliance

(75) Inventors: David Rado, Middlebury, CT (US); Michael Pardoe, Essex (GB)

Correspondence Address: Gregory J. Battersby, Esq.;GRIMES & BATTERSBY, LLP, Third Floor, 488 Main Avenue, Norwalk, CT, 06851, US

(73) Assignee: Technology Licensing Corporation

(21) Appl. No.: 10/900,726

(22) Filed: Jul. 28, 2004

(51) Int. Cl. A23C 3/00

(52) U.S. Cl. 426/523

(57) ABSTRACT

A method for preventing temperature overshoot in a cooking appliance of the type using a cooking medium such as oil, shortening, water or air to convect or conduct energy, typically in the form of heat, from the appliance to a food product, said method comprising the step of introducing a cooling element or means to the cooking medium, preferably during the cooking process and continuing it for a period of time after the product has been removed from the cooking medium so as to keep the temperature of the cooking medium in a safe cooking range. The cooling element or means may be a fan located either on the exterior or interior of the cooking appliance, as appropriate, which fan serves to introduce and/or circulate air that is cooler in temperature than the cooking medium, which air may be refrigerated to improve its cooling qualities. Another means for cooling the cooking medium comprises cooling coils, which may also be situated either within the cooking appliance or on the exterior thereof.

### BACKGROUND OF THE INVENTION

1. Field of the Invention

The present invention relates generally to the field of food preparation, and more particularly to the use of cooking appliances that employ cooking media, such as oil, water or even air for conducting energy, typically in the form of electric or gas heat, from a heating element to the product being cooked, and even more particularly to a method for preventing the temperature rise that results in said cooking media after the product has been removed, which temperature rise can damage the appliance or reduce the usable life of the cooking media.

2. Description of the Prior Art

Most cooking appliances need to put energy into a cooking medium in order to cook a food product, which energy is typically regulated so as to maintain a level of temperature to properly cook the product. This energy is usually in the form of heat conducted or convected in or around the appliance or directly into the cooking medium, which medium may be oil or water, or even air, to name just the most common examples. The amount of energy needed to be introduced in the cooking appliances varies depending on the product being cooked, the cooking medium and the efficiency of the appliance.

Once the food product is removed, in existing cooking appliances there is always an abridge temperature rise that results from the fact that the product is no longer present and absorbing the energy in the cooking medium. This temperature rise can be significant, raising the temperature in the cooking medium by five or ten degrees or more, which rise could be detrimental to the appliance and the cooking medium. Furthermore, in the case of appliances that are used repeatedly to cook food products, such as commercial fryers, the product being cooked in the next cycle or batch would be introduced to a cooking medium whose temperature is higher than that recommended by the recipe, which would have an adverse effect on the resulting cooked product. Alternatively, the food preparer may wait for the cooking medium to cool to an acceptable temperature, which wait will lengthen the amount of time required for each cycle or batch of food product being prepared.

There are currently no appliances or methods which offer the unique advantages of the method of the present invention, namely a method for preventing the rise in temperature in the cooking medium, also referred to as temperature overshoot, in a cooking appliance by introducing a cooling means during the cooking process or upon the removal of the food product being prepared in the appliance.

### SUMMARY OF THE INVENTION

Against the foregoing background, it is a primary object of the present invention to provide a method for preventing temperature overshoot in a cooking appliance using a medium for transferring energy to a food product by introducing a cooling means to the cooking medium during cooking or upon the removal of the food product.

It is another object of the present invention to provide such a method for preventing temperature overshoot in a cooking appliance that improves the lifetime of the cooking appliance.

It is yet another object of the present invention to provide such a method for preventing temperature overshoot in a cooking appliance that allows the cooking appliance to operate at maximum efficiency.

It is but another object of the present invention to provide such a method for preventing temperature overshoot in a cooking appliance that ensures both the cooking appliance and the cooking medium operate in a safe or the recommended temperature range.

It is still another object of the present invention to provide such a method for preventing temperature overshoot in a cooking appliance that minimizes heat exposure for the cooking medium.

It is yet another object of the present invention to provide such a method for preventing temperature overshoot in a cooking appliance that prolongs the lifetime of purchased cooking media such as oil.

It is but another object of the present invention to provide such a method for preventing temperature overshoot in a cooking appliance that maintains optimum cooking results for the food product.

It is another object of the present invention to provide such a method for preventing temperature overshoot in a cooking appliance that ensures uniform cooking temperature in the cooking medium so as to prevent the adverse effects of introducing food products to the cooking medium at a temperature higher than recommended or appropriate for cooking said product after the removal of a cooked food product.

It is still yet another object of the present invention to provide such a method for preventing temperature overshoot in a cooking appliance that eliminates the need to wait for the temperature of the cooking medium to drop to the recommended or appropriate temperature for cooking a food product after the removal of a cooked food product.

It is yet another object of the present invention to provide such a method for preventing temperature overshoot in a cooking appliance that allows for repeated cooking of food products in a cycle without any harmful effects to the food or the appliance caused by high appliance or cooking medium temperature.

To the accomplishments of the foregoing objects and advantages, the present invention, in brief summary, comprises a method for preventing temperature overshoot in a cooking appliance of the type using a cooking medium such as oil, shortening, water or air to convect or conduct energy, typically in the form of heat, from the appliance to a food product, said method comprising the step of introducing a cooling element or means to the cooking medium, preferably during the cooking process and continuing it for a period of time after the product has been removed from the cooking medium so as to keep the temperature of the cooking medium in a safe cooking range. The cooling element or means may be a fan located either on the exterior or interior of the cooking appliance, as appropriate, which fan serves to introduce and/or circulate air that is cooler in temperature than the cooking medium, which air may be refrigerated to improve its cooling qualities. Another means for cooling the cooking medium comprises cooling coils, which may also be situated either within the cooking appliance or on the exterior thereof.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a block diagram illustrating a cooking appliance including the means for preventing temperature overshoot of the present invention;

FIG. 2 is a flow chart illustrating the steps for preventing temperature overshoot in a cooking appliance using the method of the present invention;

FIG. 3 is a graph illustrating the temperature changes in a cooking medium during the course of six separate cook cycles without using the method of the present invention; and

FIG. 4 is a graph illustrating the temperature changes in a cooking medium during the course of six separate cook cycles using the method of the present invention.

### BRIEF DESCRIPTION OF THE PREFERRED EMBODIMENTS

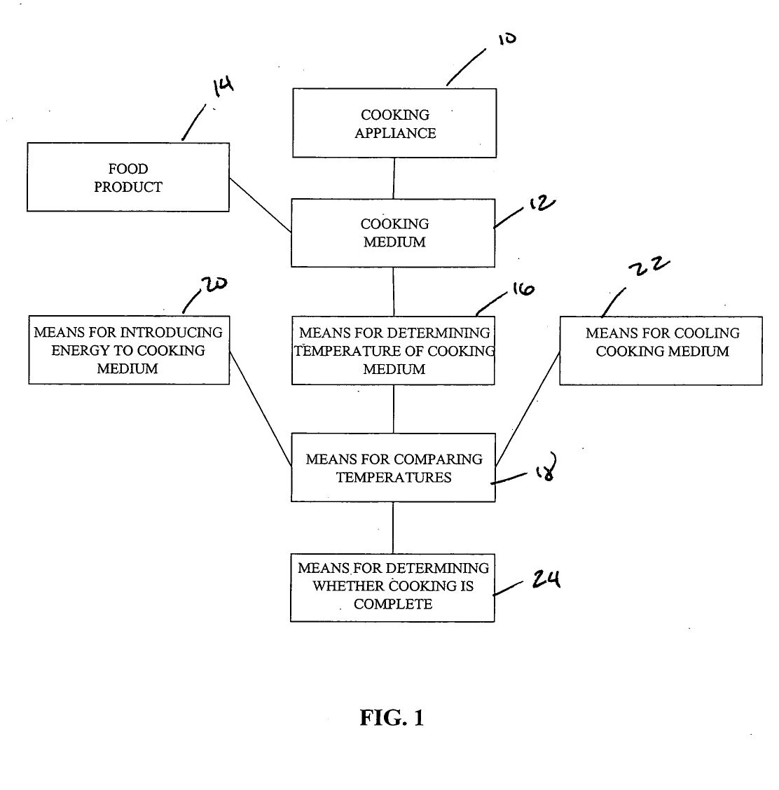

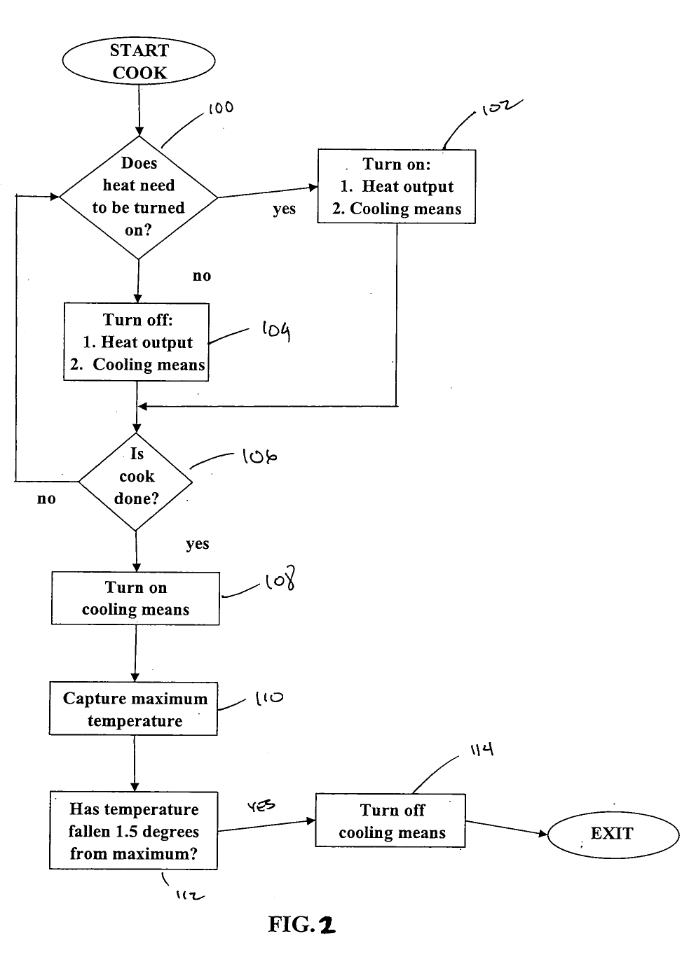

Referring to the drawings and, in particular, to FIGS. 1 and 2 thereof, the method for preventing temperature overshoot in a cooking appliance of the present invention is provided. The method of the present invention may be applied to practically any cooking appliance 10 that uses a cooking medium 12, such as oil, shortening, water or air to conduct or convect energy, usually in the form of electric or gas heat from the heating elements of the appliance to the food product 14 being cooked. Examples of cooking appliances include ovens of all types, including electric and gas, fryers, toasters, boilers, broilers, etc. Such appliances include means for determining the temperature of the cooking medium 16, said means typically comprising a thermometer or thermostat, and means for comparing said temperature to the preset or selected temperature on said device 18. This process is illustrated in step 100 on in FIG. 2, wherein the temperature of the cooking medium is compared to the preset or selected temperature. The step of checking to determine whether the heat needs to be turned on, or if energy needs to be introduced to the cooking medium, may be performed by a thermostat or other device either electrically or mechanically, which device is integrated with the means for introducing energy to the cooking medium 20 and the means for cooling the cooking medium 22.

If the means for comparing temperatures 18 determines that energy needs to be introduced, the means for introducing energy 20 is engaged, as is the means for cooling the cooking medium 22, as is illustrated in step 102. If the comparison of step 100 determines that energy is not required or that heat does not need to be introduced, the means for introducing energy 20 is turned off, as is the cooling means 22, as illustrated by step 104 in FIG. 2.

Most cooking appliances 10 also include a means for determining whether the cooking is complete 24, typically either a timer or a thermometer that may be inserted directly within the food product 14. Said means for determining whether the cooking is complete 24 determines whether the time required for cooking has elapsed or the food product 14 has reached the desired temperature. The determination of the completion of cooking is illustrated in step 106 of FIG. 1. In the event that cooking is not complete the process continues with the step of determining whether energy needs to be introduced 100. In the event that cooking is complete, the means for cooling 22 is turned on, as illustrated in step 108, and the food product 14 is removed from the cooking medium 12.

The maximum temperature of the cooking medium 12 that is appropriate for cooking the food product 14 is captured in step 110, which maximum temperature is compared to the temperature of the cooking medium 12, as illustrated in step 112. Once the temperature of the cooking medium 12 falls 1.5 degrees under maximum temperature, or if the temperature of the cooking medium 12 is 1.5 degrees under the maximum temperature upon the removal of the food product 14, the means for cooling 22 is turned off, and the cooking appliance 10 is ready for a new food product.

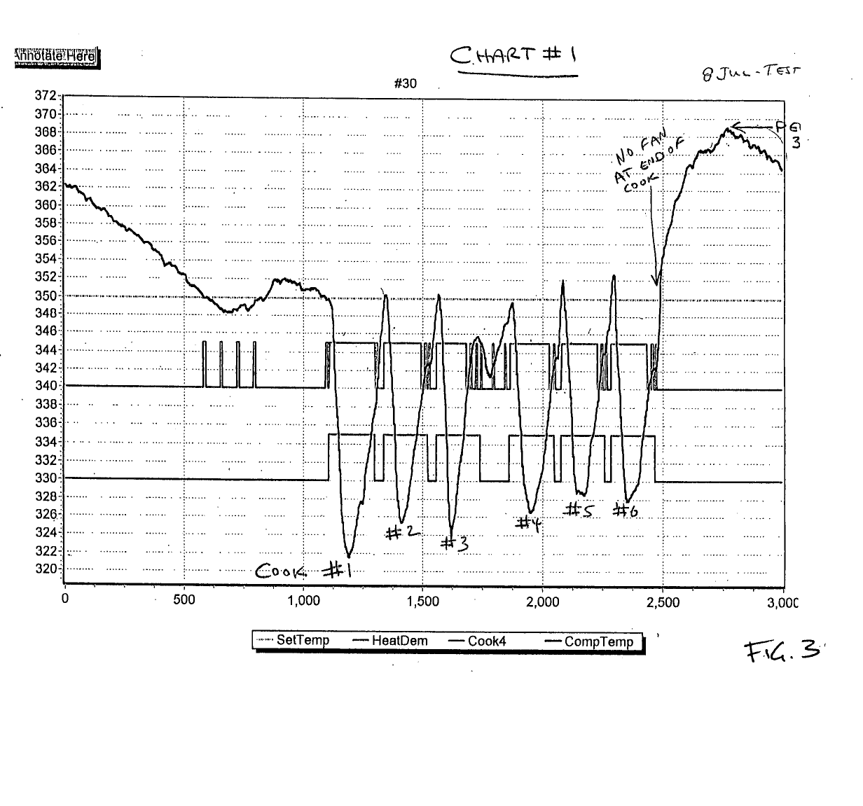

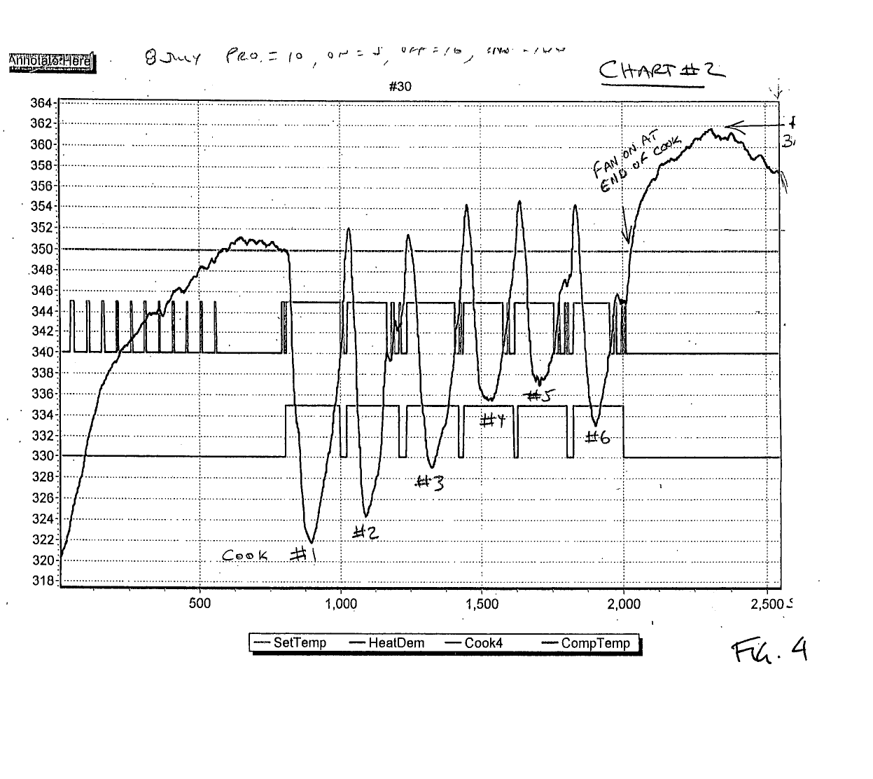

In the preferred embodiment, the means for cooling comprises 22 a fan or cooling coils, which elements may be within the cooking medium 12, in the cooking appliance 10 or exterior to the cooking appliance 10. An illustration of the effectiveness of the method of the present invention is illustrated in FIGS. 3 and 4, which show the temperatures of a cooking medium 12 during six consecutive cook cycles in a cooking apparatus 10. FIG. 3 illustrates the temperature of the cooking medium 12 without a cooling means 22. Note that the initial temperature drop is due to putting frozen French Fries in a vat of 350 degree Fahrenheit oil. After the six cook cycles re complete, the temperature in the vat rises to 369° F. due to the “temperature flywheel effect,” which is the temperature rise attributable to the removal of a food product 14 from the cooking medium 12, thereby eliminating the means for absorbing the energy being provided by the cooking appliance 10. The operator must wait until the temperature drops to less than 362° F. before he can use the cooking apparatus, which can take at least 10 minutes or more.

FIG. 4 illustrates the same process of six consecutive cook cycles of frozen French Fries, this time utilizing the method of the present invention. It can be seen that at the end of the last cook cycle, the maximum temperature rise is 362° F., which is within the acceptable cooking temperature for the food product 14, and an operator can start another cook at any time. This improves total efficiency of the cooking appliance 10, as well as improving the life of the cooking medium 12.

In an alternative embodiment, the means for cooling 22 can comprise a separate object that may be inserted within the cooking medium 12 upon the removal of the food product 14, which separate object should be composed of a material that is safe for the cooking medium 12 and cooking appliance 10, and can absorb the energy provided by the cooking appliance 10 to maintain the temperature of the cooking medium 12 until a new food product 14 is introduced therein. This separate object may be a reusable material, or alternatively a “sacrificial” object that is discarded after the new food product 14 is introduced.

Having thus described the invention with particular reference to the preferred forms thereof, it will be obvious that various changes and modifications can be made therein without departing from the spirit and scope of the present invention as defined by the appended claims.

Wherefore, we claim:

1. A method for preventing an increase in temperature in a cooking appliance and for maintaining an ideal temperature range in a cooking medium for transferring energy to a food product within said cooking appliance upon the removal of said food product from said cooking medium, said method comprising the step of introducing a cooling means to said cooking medium prior to said removal of said food product.

2. The method of claim 1, further including the step of continuing said cooling means after said removal of said food product until the temperature of said cooking medium is within said ideal temperature range.

3. The method of claim 1, wherein said step of introducing a cooling means comprises the operation of a fan situated within said cooking appliance to circulate air cooler in temperature than said cooking medium within said cooking appliance.

4. The method of claim 1, wherein said step of introducing a cooling means comprises the operation of a fan situated on the exterior of said cooking appliance to circulate air cooler in temperature than said cooking medium about the surface of said cooking appliance.

5. The method of claim 1, wherein said step of introducing a cooling means comprises the operation of cooling coils situated within said cooking appliance, said cooling coils being cooler in temperature than said cooking medium.

6. The method of claim 1, wherein said step of introducing a cooling means comprises the operation of cooling coils situated on the exterior of said cooking appliance, said cooling coils being cooler in temperature than said cooking medium.

7. A method for preventing an increase in temperature in a cooking appliance and for maintaining an ideal temperature range in a cooking medium for transferring energy to a food product within said cooking appliance upon the removal of said food product from said cooking medium, said method comprising the step of introducing a cooling means to said cooking medium prior to said removal of said food product and continuing said cooling means after said removal of said food product until the temperature of said cooking medium is within said ideal temperature range, said step of introducing a cooling means comprising the operation of a fan situated within said cooking appliance to circulate air cooler in temperature than said cooking medium within said cooking appliance.

8. A cooking appliance that prevents a sudden increase in temperature and maintains an ideal temperature range in a cooking medium used to transfer energy to a food product within said cooking appliance upon the removal of said food product from said cooking medium, said cooking appliance comprising:
means for determining the temperature of said cooking medium;
means for comparing said temperature of said cooking medium to said ideal temperature range;
means for introducing energy to said cooking medium; and
means for cooling said cooking medium prior to and subsequent to the removal of said food product.

9. The cooking appliance of claim 8, wherein said means for comparing further includes means to engage said means for introducing energy to said cooking medium if said temperature of said cooking medium is below said ideal temperature range, and further including means to engage said means for cooling if said temperature of said cooking medium is above said ideal temperature range.

10. The cooking appliance of claim 9, further including means for determining whether cooking is complete.

11. The cooking appliance of claim 8, wherein said cooking appliance is selected from the group consisting of ovens, fryers, toasters, broilers and boilers.

12. The cooking appliance of claim 8, wherein said means for cooling said cooking medium is selected from the group consisting of fans and cooling coils.
